(19) United States
(12) Patent Application Publication
(10) Pub. No.: US 2026/0221136 A1
(43) Pub. Date: Jul. 30, 2026

(54) Query Optimization Via Truncation Detection

(71) Applicant: Comcast Cable Communications, LLC, Philadelphia, PA (US)

(72) Inventors: Rui Min, Vienna, VA (US); Frederick Baldwin, New York, NY (US); Karun Kumar, Washington, DC (US); Alex Goryachkovsky, Livermore, CA (US)

(21) Appl. No.: 19/037,546

(22) Filed: Jan. 27, 2025

(51) Int. Cl. G10L 15/22; G10L 15/30; G10L 25/51

(52) U.S. Cl. CPC G10L 15/22; G10L 25/51; G10L 2015/223; G10L 2015/228; G10L 15/30

(57) ABSTRACT

Systems, apparatuses, and methods are described for processing a voice command to determine whether an error occurred, and/or to determine or recover an intended command. Abnormalities in the voice command, such as truncation, may be detected, for example, based on volume levels of the command, and where within the command the volume levels occur. The intended command may be determined, for example, based on an indication of (and/or information regarding) truncation (e.g., type, probability of truncation) and based on common and/or popular commands. One or more probable commands, as well as associated confidence levels, may be selected as the intended command. The probable commands may be further evaluated based on context, environmental data, and/or experience data of a user. One or more actions may be performed based on the evaluation.

### BACKGROUND

Automatic speech recognition (ASR) systems are used to convert a user's speech into text. Low quality utterances may generate broken or incomprehensible transcripts, causing errors in an application that an ASR system supports. Technologies such as noise reduction and voice activity detection are used for improving the quality of speech recognition systems.

### SUMMARY

The following summary presents a simplified summary of certain features. The summary is not an extensive overview and is not intended to identify key or critical elements.

Systems, apparatuses, and methods are described for processing an inputted (e.g., recorded) voice command to recover an intended (or probable) command. Abnormalities in the recorded voice command such as truncations may be detected based on volume of voice. The intended command may be determined, for example, based on information indicating truncation and/or common and/or popular commands. Information indicating truncation (e.g., indicating type of truncation, likelihood of truncation, etc.) may, for example, be used in connection with a transcript that includes terms sensitive to truncation. Also or additionally, other abnormalities such as clicking, clipping may be determined and used for optimizing inputted voice commands. One or more probable commands as well as their confidence levels may be generated for the intended command. The probable commands may be further evaluated based on context of a device associated with the voice command and/or experience data of a specific user. One or more actions may be performed based on the evaluation.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 shows an example in which truncation of a voice command may occur.

FIG. 4 shows example functional components in a voice control system.

FIG. 5 shows an example data flow associated with operations performed by one or more computing devices.

FIG. 6A, FIG. 6B, and FIG. 6C show example types of truncations.

FIG. 7A shows an example sound graph for a recorded utterance with no truncation.

FIG. 7B and FIG. 7C show examples of abnormal sound graphs associated with truncated utterances.

FIG. 7D shows an example sound graph with a click sound.

FIG. 8A, FIG. 8B, and FIG. 8C are a flow chart showing steps of an example method for processing an inputted utterance that may comprise truncation or other abnormalities.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

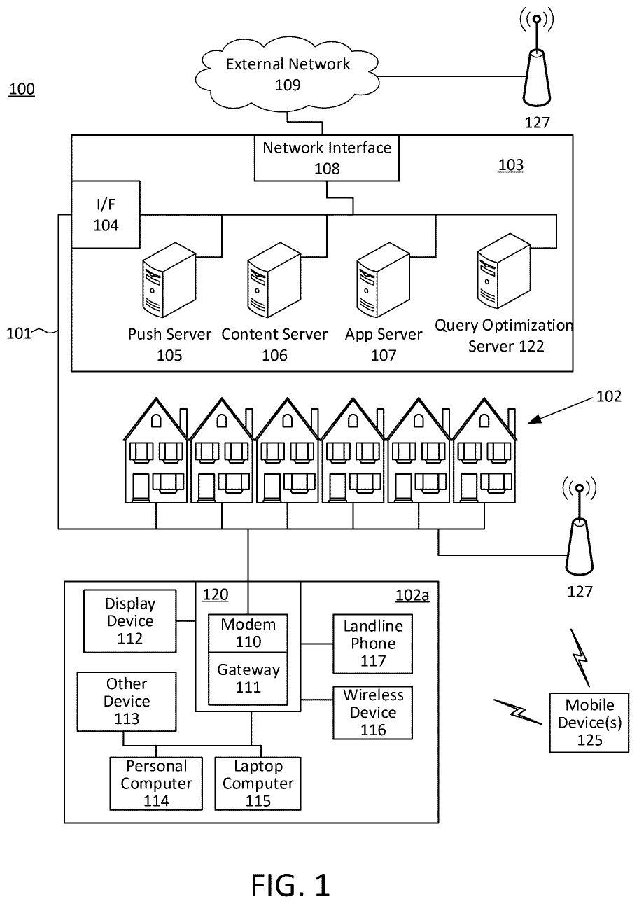

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the query optimization server 122 (described below), additional push, content, and/or application servers, and/or other types of servers. The query optimization server 122 may be configured to determine a probable query or command (or an intended command) based on an inputted utterance (e.g., a recorded utterance, user speech, etc.). For example, the query optimization server 122 may detect presence/absence/type of truncation in the inputted utterance. The query optimization server 122 may compare the inputted utterance to common or popular commands. The query optimization server 122 may determine (e.g., select) a probable command based on the truncation detection and the common commands. Although shown separately, the push server 105, the content server 106, the application server 107, the query optimization server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein. Also or alternatively, one or more of servers 105, 106, 107, and 122, and/or other servers, may be part of the external network 109 and may be configured to communicate (e.g., via the local office 103) with computing devices located in or otherwise associated with one or more premises 102.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on-or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

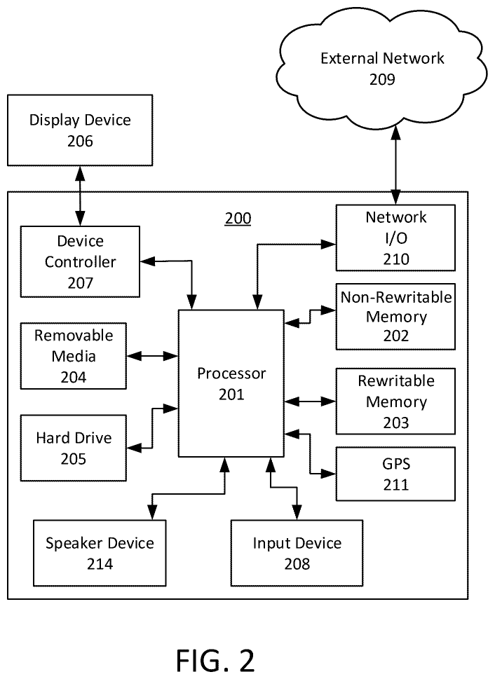

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109, the remote control 320, the premises computing device 315) and any other computing devices discussed herein. The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker device 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

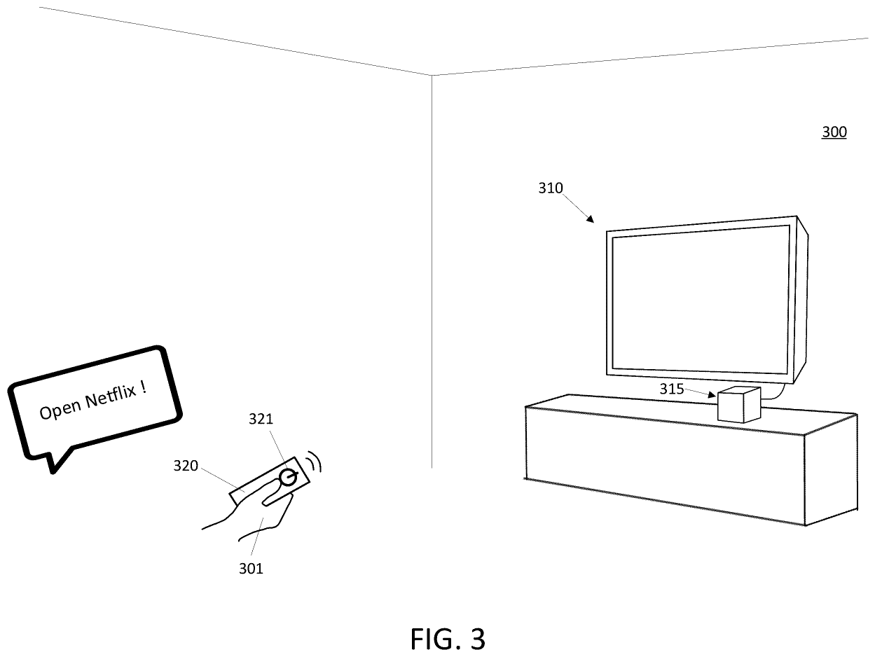

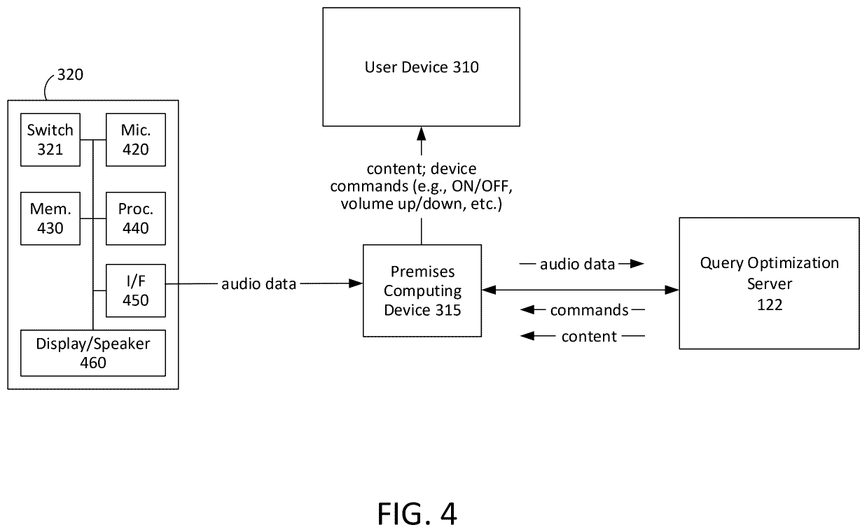

FIG. 3 shows an example in which truncation of a voice command may occur. In the example of FIG. 3, a voice control system 300 may comprise a user device 310 such as a multi-media device (e.g., a television or other display device), a premises computing device 315 (e.g., a gateway, an STB, a multi-media device, or other computing device), and a remote control device 320. For example, the user device 310 may correspond to the display device 112, etc. in FIG. 1. The premises computing device 315 may correspond to the modem 110, the gateway 111, the computer 114/115, the other device 113, etc. in FIG. 1. The remote control device 320 may correspond to the wireless device 116, the other device 113, etc. in FIG. 1. The premises computing device 315 may communicate with the network to request content (e.g., upstream to request content), receive content (e.g., downstream to receive content), output content to the user device 310, cause content to be recorded, etc. The premises computing device 315 may be a separate device and/or may be incorporated into the user device 310. The user device 310 and/or the computing device 315 may communicate with the remote control device 320, for example, to receive voice commands. The remote control device 320 may comprise a switch (e.g., button) 321 and other components to be shown and/or described in FIG. 4. A user may generate an utterance (e.g., speak a voice command), and the utterance may be detected by and/or inputted into the remote control device 320 that may be held in a hand 301 of the user. The utterance may be sent (e.g., transmitted) to the computing device 315 associated with the user device 310. The computing device 315 may process signals of the utterance. Alternatively or additionally, the computing device 315 may send the utterance as audio data to the query optimization server 122 (see FIG. 1) for signal processing. The computing device 315 and/or the query optimization server 122 may determine probable commands and corresponding actions associated with the user device 310, based on processed signals. For example, the computing device 315 and/or the query optimization server 122 may determine that the command is “Open Netflix!” A corresponding action may be for the user device 310 to open the Netflix application (e.g., APP), if this application is available on this user device 310.

In the example of FIG. 3, the voice control system 300 may allow manual control by a user for the system to detect and record an utterance such as a voice command. For example, the system may start and/or stop recording based on a user pressing the switch (e.g., button) 321. For example, the user may press the button 321 to indicate the start of recording and may press the button 321 again to indicate the end of the recording. For another example, the user may press and hold the button 321 to indicate a recording mode and may release the button to indicate the end of the recording mode. The recording may be performed for an utterance that this or another user generates. For example, the remote control device 320 may perform the recording, and may send a recorded utterance to the user device 310 and/or the computing device 315 automatically or based on a trigger (e.g., pressing a button). To record a complete utterance or a voice command, the utterance may need to occur in good timing with the manual control. For example, the utterance may need to start no earlier than when the button 321 is pressed, and may need to end no later than when the button 321 is pressed again. However, less ideal timings may happen. For example, a user might press the button 321 too late (e.g., after an utterance has already started) and/or press the button 321 too early (e.g., before an utterance ends), due to various reasons (e.g., haste, poor coordination, etc.). For example, a user may release the button 321 too soon or fail to press the button 321 all the way during the utterance. In addition, conditions besides manual control may affect the detection, recording, or transmission of an utterance. For example, the remote control device 320 may be at low battery power. For example, there may be network issues (e.g., weak WIFI signals). These and other reasons might cause truncation (e.g., head truncation, tail truncation, middle truncation) to occur in a recorded utterance.

FIG. 4 is a block diagram showing functional components in a voice control system (e.g., the voice control system 300). The remote control device 320 may comprise the switch 321, one or more acoustic sensors such as a microphone 420, a memory device 430, a processor 440, a communication interface (e.g., I/F) 450, a display/speaker 460, etc. The switch 321 may be configured to turn on or off the microphone 420 (e.g., a microphone device or a microphone circuit). The switch 321 may be manually operated, and may be in the form of a push button, a rotary switch, a toggle switch, and/or any other form that may apply, for example, to the remote control device 320. For example, the switch 321 may be the button as described with respect to FIG. 3. Alternatively or additionally, the switch 321 may be an electric switch that may be activated by electric signals. The microphone 420 may include any microphone and/or associated circuit. For example, the microphone 420 may be associated with one or more filters, an analog-to-digital (A/D) converter, a noise reduction unit, etc. The microphone 420 may receive sound input (e.g., the utterance) and convert it into electrical signals. The electrical signals may be stored in the memory device 430. Also or alternatively, the electrical signals may be sent (e.g., digitally transmitted, e.g., as a .wav file) to the computing device 315, for example, via the communication interface 450. The memory device 430 may be any memory devices such as random-access memory (RAM), flash memory, etc. Data stored in the memory device 430 may be retrieved and sent to an outside device, via the communication interface 450. The switch 321 may optionally be configured to enable or disable signal transmissions at the communication interface 450. For example, a user may press the switch (e.g., button) 321 to confirm sending a recorded utterance. The communication interface 450 may comprise one or more of a transmitter, a receiver, a transceiver, a digital-to-analog (D/A) converter, an amplifier, etc. The communication interface 450 may be, for example, an infrared (IR) I/F, a wireless I/F, etc. The communication interface 450 may support wireless communication protocols such as WIFI, BLUETOOTH, NFC, etc. Although not shown, the communication interface 450 may be configured to receive signals from the outside such as the computing device 315 and to send the signals to the display and/or speaker 460. The display and/or speaker 460 may convey the signals visually and/or via sound. The processor 440 may be configured to control operations of the remote control device 320 (e.g., operations between the switch 321, the microphone 420, the memory device 430, the communication interface 450, and/or the display/speaker 460). For example, instructions for operations may be stored in the memory device 430. The processor 440 may be any processors, microprocessors, microcontrollers, etc. that may apply to a remote control device.

A user may operate (e.g., press) the switch (e.g., button) 321, which may cause the processor 440 to begin receiving sound (e.g., utterance) via the microphone 420. The microphone 420 and/or the processor 440 may convert the sound to audio data (e.g., .wav file). The audio data may be sent (e.g., transmitted) to the computing device 315 associated with the user device 310, for example, via the communication interface (e.g., I/F) 450. The processor 440 may stop receiving sound via the microphone 420 and stop creating and/or sending audio data, for example, if the user releases the switch 321.

The computing device 315 may receive the audio data and may send the audio data to the query optimization server 122 for determining what command the audio data represents. The query optimization server 122 may send back one or more commands (e.g., probable commands) that it determines, for example, based on the audio data. The query optimization server 122 may send back content (e.g., audio, video data) to be output via the user device 310, for example, if the query optimization server 122 determines that the audio data sent from the computing device 315 requests the content. Also, or alternatively, the query optimization server 122 may send a command to the computing device 315 to cause the user device 310 to perform a device operation (e.g., ON/OFF, volume up/down, picture adjustment, etc.), for example, if the command is determined based on the audio data from the computing device 315. The computing device 315 may also output content to the user device 310 so that the user device 310 may output (e.g., display) video and/or audio for content. The query optimization server 122 may determine what the audio data, received from the computing device 315, represents (e.g., what command, what content requested, etc.), and may perform other actions as described in connection with subsequent figures. Also or alternatively, the computing device 315 may process the audio data. For example, the computing device 315 may determine one or more probable commands based on the audio data. Data (e.g., audio data, commands, etc.) may be stored or saved temporarily or permanently in memory devices (not shown) associated with the query optimization server 122 and/or the computing device 315. These memory devices may be separate from and/or incorporated into the query optimization server 122 and/or the computing device 315. These memory devices may be any memory devices such as random-access memory (RAM), dynamic random-access memory (DRAM), non-volatile memory (NVM), solid-state drives (SSDs), flash memory, etc. For example, these memory device may be the rewritable memory 203 in FIG. 2.

The computing device 315 and/or the query optimization server 122 may comprise information about the user device 310 and may determine actions based on both the command and the user device information. For example, the computing device 315 may determine to send a message to the user (e.g., via the user device 310 and/or the remote control device 320), based on Netflix not being available for the user device 310 and a command for opening Netflix. For example, the message may instruct the user to either change the voice command or install Netflix on the user device 310 and/or computing device 315. Although not shown in FIG. 4, the user device 310 may provide confirmation and/or feedback to the computing device 315.

Examples as described in connection to FIG. 3 and FIG. 4 are not limiting, and alternate configurations may be implemented. For example, some or all functions described above (or elsewhere herein) as performed by the query optimization server 122 may be performed by the computing device 315 and/or by the remote control device 320. The computing device 315 may be incorporated into and/or be a part of the user device 310. In addition to, or instead of, being received by the remote control device 320, user utterances may be received by a computing device (e.g., for a home automation system) that includes a hands-free microphone that detects when an utterance starts (e.g., by a trigger word) and when an utterance is over (e.g., by sound dropping below some level for some amount of time). For example, the computing device 315 may be part of the user device 310 and may include a hands-free microphone to receive utterances. Truncation may happen much less often for a hands-free microphone. Truncation may occasionally be caused by issues such as low battery power of the remote control device 320 and/or unstable network (e.g., weak wireless signals).

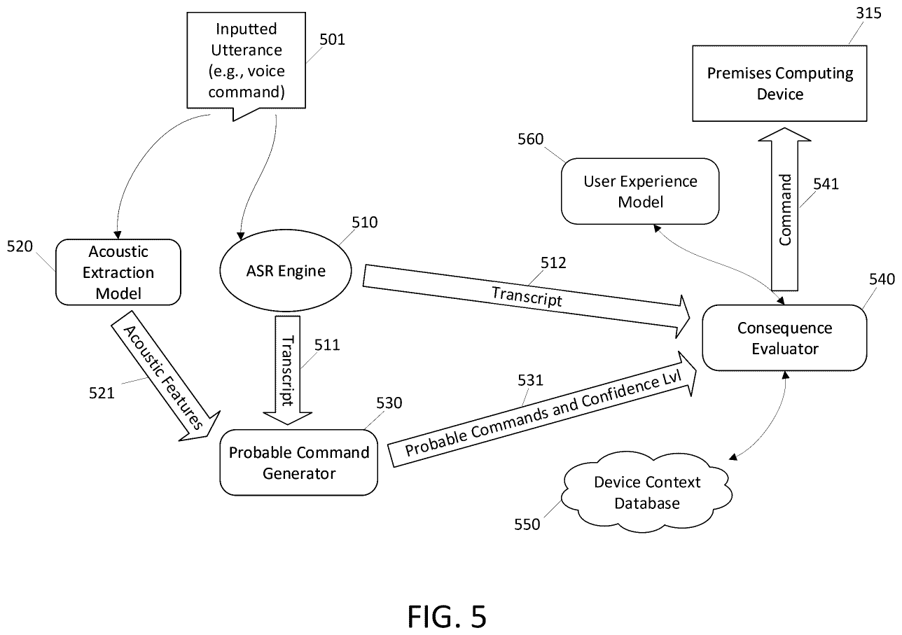

FIG. 5 shows example data flows associated with operations that may be performed by the query optimization server 122, the computing device 315, and/or other devices shown in FIGS. 3 and 4. The operations may be performed by a single computing device, or may be distributed across multiple computing devices (e.g., multiple devices, servers, etc.). FIG. 5 may show multiple software modules including an ASR engine 510, an acoustic extraction model 520, a probable command generator 530, a consequence evaluator 540, and a user experience model 560. Each of the modules may be software executing on the query optimization server 122, the computing device 315, and/or on one or more other computing devices to perform operations described herein.

All or part of an utterance (e.g., a voice command or other utterance) may be inputted to a computing device (e.g., the (premises) computing device 315), for example, via a microphone (e.g., the microphone 420). The voice command may be captured (e.g., recorded, streamed) and a captured voice command may be inputted as audio data (e.g., a sound file) to the computing device. The captured voice command may be incomplete (e.g., truncated). The captured voice command may contain noise. The captured voice command may have non-standard pronunciations (e.g., mispronunciation, accent, etc.) that may cause difficulty of understanding.

An ASR engine 510 may process audio data (e.g., an inputted utterance 501 such as a voice command) received from the computing device 315 and may output a transcript. The ASR engine 510 may comprise any ASR software available. For example, the ASR engine 510 may comprise Google Assistant or Samsung Bixby. The transcript may be a text version of the inputted utterance 501. The inputted utterance 501 may be complete or may be incomplete (e.g., truncated), due to reasons such as late recording (e.g., pressing button late), low battery power, unstable network (e.g., WIFI), etc. For example, a transcript for a complete voice command “Open Netflix!” may be “Open Netflix.” For example, if a voice command containing “Channel 50” is truncated in the inputted voice command (e.g., “annel 50”), the transcript may contain “annel 50” instead of “Channel 50.” For example, a user input error or a dying battery may cause tail-truncated commands. For example, unstable network conditions may cause dropped packets during transmission of a recorded voice command. The transcript from the ASR engine 510 may be outputted to a probable command generator 530 (as shown by arrow 511) and/or to a consequence evaluator 540 (as shown by arrow 512), which are described below.

An acoustic extraction model 520 may perform digital signal processing on the received audio data (e.g., the inputted utterance 501). Specifically, the acoustic extraction model 520 may obtain acoustic features of the voice command and may output the acoustic features (e.g., as metadata), for example, to the probable command generator 530 (as shown by arrow 521). The acoustic features may include truncation, clicks, other noise, voice type, etc.

A recorded utterance (e.g., a voice command), if truncated and unless additional action is taken, may cause confusion or be misinterpreted by the server 122. Determining whether a recorded utterance is truncated or not, and which type of truncation it is may provide useful information for the server 122 to predict or identify an original utterance or true intention of a user. There may be three types of truncations: head truncation, middle truncation, and tail truncation.

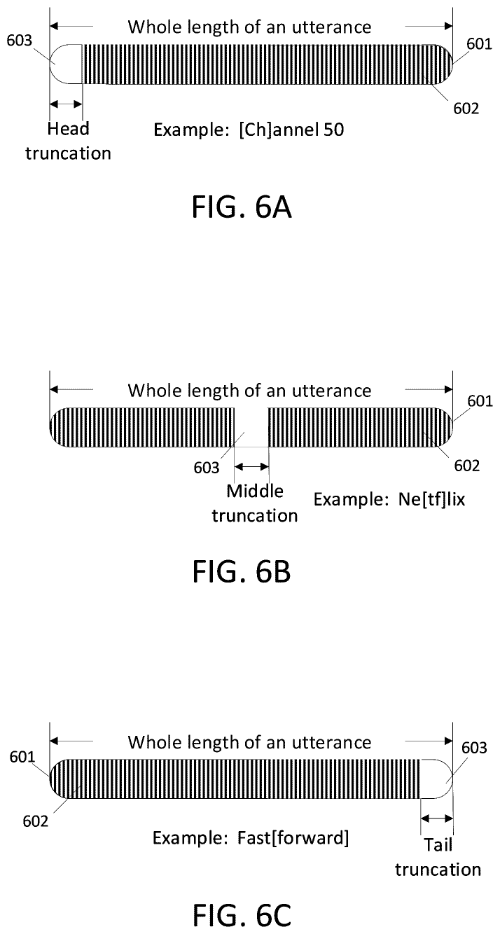

FIG. 6A, FIG. 6B, and FIG. 6C show examples for the three types of truncations. For convenience, FIG. 6A, FIG. 6B, and FIG. 6C, represent an utterance 601 as a shape with two ends having reduced sizes (e.g., a drum shape). A shaded portion 602 may indicate audio data for the utterance (e.g., captured utterance such as the inputted utterance 501). The blank portion 603 may indicate a portion of the utterance that has no audio data (e.g., uncaptured utterance). FIG. 6A shows an example of head truncation. In FIG. 6A, the blank portion 603 is at the beginning of the utterance 601. A head truncation may occur if a beginning portion of an utterance is not captured (e.g., recorded, streamed). A captured utterance may start from a middle part of a word. Alternatively, one or more words at the beginning may be lost. For example, if an utterance begins with “Channel 50”, an example head truncated case may be “annel 50.” FIG. 6C shows an example of tail truncation. In FIG. 6C, the blank portion 603 is at the end of the utterance 601. A tail truncation may refer to a situation when an end portion of an utterance is missing in a captured utterance. Similar to head truncation, one or more words or a part of a word at the end may be lost. An end truncation example may be “fast” with “forward” missing, for a voice command “fastforward.” For another example, the word “YouTube” may sound like “U2” in an end truncation case. FIG. 6B shows an example of middle truncation. In FIG. 6B, the blank portion 603 is neither at the beginning nor at the end of the utterance 601. A middle truncation may happen if the missing words or part of a word occurs in a position other than the beginning or the end of an utterance. For example, in a voice command “Open Netflix!”, “tf” is not recorded, for example, due to an issue with the microphone. A recorded voice command may only have “Open Ne lix!”. Truncated utterances, if not corrected or processed, may cause frustration in user experience, as a voice-controlled device (e.g., the user device 310) may perform no or wrong actions in response to the truncated utterances. Note that the illustrations and examples in FIG. 6A, FIG. 6B, and FIG. 6C are merely examples. For example, the length of the blank portion 603 may be other lengths, and the position of the blank portion 603 in FIG. 6B (middle truncation) may be other positions. For example, an utterance 601 may comprise more than one type of truncation (e.g., both head truncation and tail truncation, all three types of truncations, etc.)

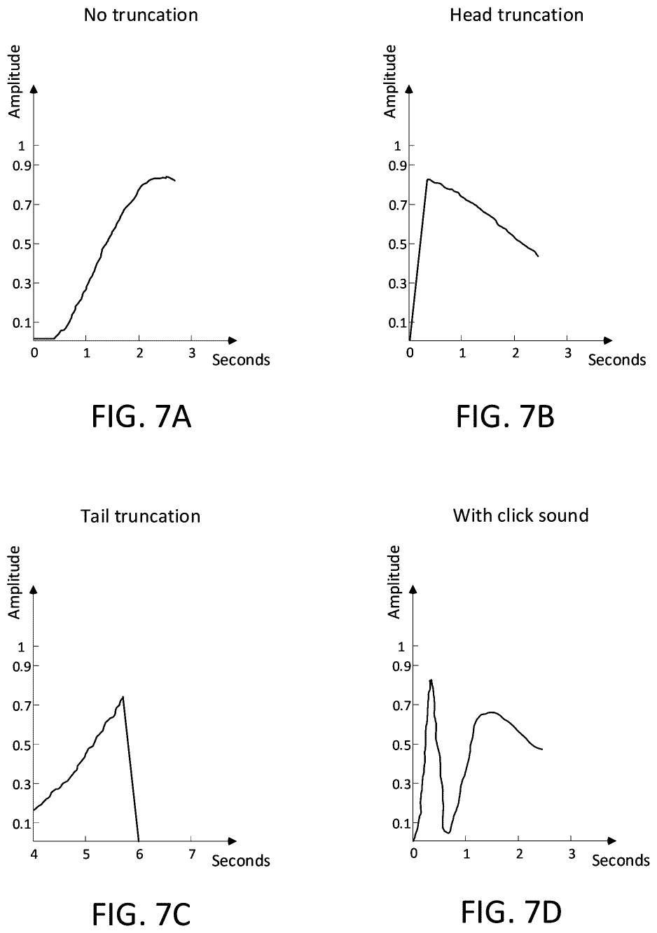

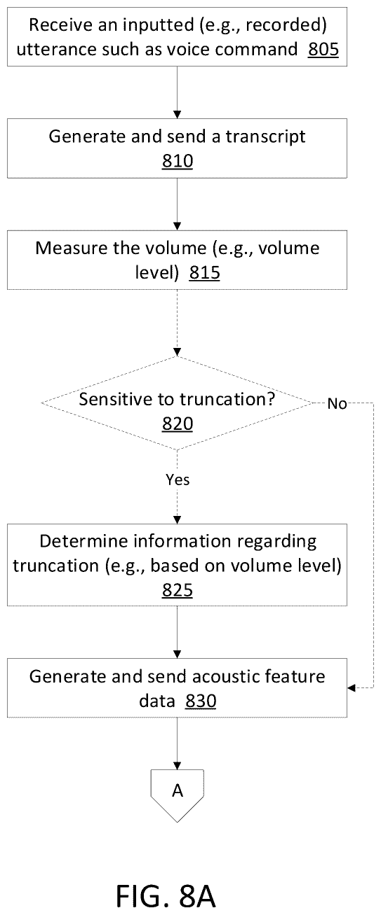

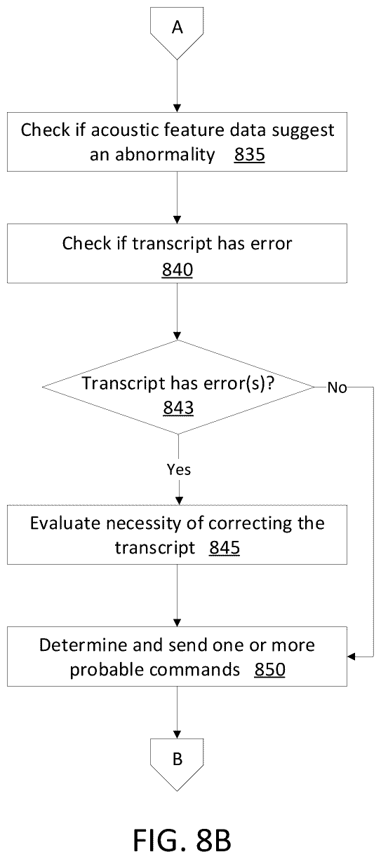

FIG. 7A shows an example sound graph for a captured (e.g., recorded, streamed) utterance with no truncation. FIG. 7B and FIG. 7C show examples of abnormal sound graphs associated with truncated utterances (e.g., voice commands). As shown in FIG. 7A, for example, a recorded utterance with no head truncation may have a sound graph that starts with low or zero amplitude (representing signal volume, energy, or intensity of an utterance) and gradually rises to bigger amplitudes. For example, the word “Channel” may sound loudest at the letter “a” and may have less volume before and after the letter “a”. A head or tail truncated utterance, on the other hand, may have a high volume (e.g., volume level) at the beginning or at the end. As shown in FIG. 7B, for example, a recorded utterance with a head truncation may have a high volume at the very beginning (or a high starting volume, a high starting sound), with a steep rising line which indicates no transition. The sound graph in FIG. 7B may indicate that a part of the utterance has been cut from the very beginning of recording, or a user was already speaking before the recording started. Similarly, in FIG. 7C, for example, a recorded utterance with a tail truncation may have a high volume at the very end of recording, with a steep falling line which indicates no transition. The sound graph in FIG. 7C may indicate that a part of the utterance has been cut from the very end of recording, or a user was still speaking after the recording ended. Although not shown, a recorded utterance with a middle truncation may have at least one extreme change in volume, somewhere between the very beginning and the very end of recording (e.g., in mid-utterance), that may indicate signal loss.

Returning to FIG. 5, the acoustic extraction model 520 may determine an indication of, and/or information regarding, truncation (e.g., the probability and/or type of truncation) based on volume characteristics as described herein. The acoustic extraction model 520 may analyze a recorded utterance (e.g., the inputted utterance 501), and may determine (e.g., measure) and obtain data about volume (or amplitude, volume level) in relation to time. For example, change of volume or level of volume at important time points such as the beginning and the end of a recorded utterance may be determined and/or noted. The data may comprise time/amplitude values and/or visuals (e.g., graphs like the ones in FIGS. 7A-7D). The acoustic extraction model 520 may determine indication of, and/or information regarding truncation (e.g., type of truncation, probability of truncation) based on that data. For example, the acoustic extraction model 520 may compare the data with predetermined reference data or thresholds and generate conclusions of whether a head truncation and/or a trail truncation exists. For example, the acoustic extraction model 520 may extract a short segment around (e.g., 500 milliseconds after or before) the very beginning time or the very end time of a recorded utterance, obtain and convert raw data, and calculate the volume, using available software or programming tools such as Python. The reference data or thresholds may be studied and obtained beforehand, and may be inputted to the acoustic extraction model 520. For example, a direct high volume beginning may indicate a head truncation. The acoustic extraction model 520 may determine that a head truncation may exist, for example, if an amplitude (or volume level) at the very beginning (e.g., at 500 milliseconds) exceeds a threshold (e.g., 0.5). The acoustic extraction model 520 may determine that a tail truncation may exist, for example, if an amplitude at the very end (e.g., 500 milliseconds to end of recording) exceeds a threshold (e.g., 0.5).

The acoustic extraction model 520 may make an incorrect determination for a truncation, for example, if noise occurs at the very beginning or at the very end of a recorded utterance. For example, a user may manually trigger recording of an utterance by turning on a switch (e.g., pressing the switch (e.g., button) 321 in FIG. 3). As a result, a click sound may appear at the very beginning of a recorded utterance. The click sound might not be heard by the user, but may affect the beginning of the recorded utterance. FIG. 7D shows an example sound graph with a click sound. At the very beginning of the sound graph in FIG. 7D, there is an example peak amplitude which represents the click sound. The acoustic extraction model 520 may determine that a head truncation exists, for example, based on the amplitude at the very beginning (e.g., at 500 milliseconds) exceeding 0.5. This determination is incorrect, as this amplitude does not belong to the utterance. The acoustic extraction model 520 may avoid or reduce this incorrect determination, for example, by identifying the noise such as the click sound. A click sound may indicate no head truncation. The acoustic extraction model 520 may determine the noise such as the click sound, based on the volume of sound. For example, a brief peak at the beginning may indicate a click sound. For example, the acoustic extraction model 520 may obtain volume (e.g., volume level) for a time point when the click sound usually ends (e.g., at around 700 milliseconds). The acoustic extraction model 520 may determine a high possibility of having a click sound, for example, if the volume at the time point is below a threshold (e.g., 0.05). Although a click sound is used to describe a typical example, the noise may be or comprise other noise such as a banging sound (e.g., caused by dropping a remote control device), a scratching sound, a coughing sound, etc. Any other noise, if having a pattern, may be learned. Results of learning may be used by the acoustic extraction model 520 to identify the noise, for example, if the noise may affect truncation determination.

Also, or alternatively, the acoustic extraction model 520 may comprise a machine learning model. The machine learning model may be trained based on a large amount of data associated with truncations and other noises such as click sounds. For example, a few thousand recorded utterances may be collected with normal cases (e.g., no truncation, no other noises), truncated cases (e.g., head truncation, middle truncation, tail truncation), click sound cases, etc. These utterances may be annotated (e.g., manually) based on the different types of cases. The sound data of the utterances and the annotations may be fed to the acoustic extraction model 520 to train the model into a classifier. The trained model may learn patterns of different truncations and noises, and may apply the patterns to new data. For example, the acoustic extraction model 520 may have learned the pattern of a click sound at the very beginning of a recorded utterance and may recognize a highly likely click sound in a new utterance if the new utterance contains this pattern. For example, the acoustic extraction model 520 may have repeatedly learned head truncation cases for the word “channel” and may recognize a highly likely head truncation in a new utterance for the same word. Such training of the machine learning model may be effective, for example, in a field where utterances are relatively limited (e.g., associated with a finite set of available functions and content of voice-controlled devices) and repetitive (e.g., as voice commands), and where there may be typical noises (e.g., click sounds, dropping sounds, scratching, coughing, etc.). Such a field may be related to voice-controlled smart multi-media players (e.g., televisions). Such a field may also or alternatively involve voice-controlled devices, for example, in the medical fields (e.g., hospital, patients, rehabilitation, senior care, etc.), toy fields (e.g., remote controlled toy vehicles, toy animals, etc.), specialized robot fields, education fields (e.g., smart classroom, interactive machine tutoring, etc.), etc. The acoustic extraction model 520 may output acoustic features (normal and/or abnormal features) including truncation types, noise types, voice types, etc. Additionally, the acoustic extraction model 520 may output a probability score (e.g., in the form of a percentage) for an abnormal acoustic feature (e.g., a truncation type), to show how likely the abnormality is. A machine learning model may compute the probability of a feature or an outcome using a probabilistic framework. For example, probabilities may be obtained using machine learning models such as neural networks (e.g., multilayer perceptron (MLP)).

In addition, the acoustic extraction model 520 may determine the probability (e.g., possibility, likelihood) and/or type of truncation based on other data. For example, the acoustic extraction model 520 may receive data on hardware status (or status of hardware, e.g., battery voltage for the remote control device) and network quality (e.g., strength of WIFI signals), for example, from the remote control device 320. For example, the hardware status may be associated with generating the recorded utterance. The network quality may be associated with receiving the recorded utterance. The acoustic extraction model 520 may determine that truncation is more possible, for example, based on the battery voltage being low and/or the network quality being poor.

The acoustic extraction model 520 may generate acoustic feature data based on the determined acoustic features (and corresponding probabilities), for example, for each inputted voice command. The acoustic extraction model 520 may send the generated acoustic feature data to the probable command generator 530, as shown by arrow 521. The acoustic features may comprise a head truncation, a tail truncation, a click sound, etc., as already described herein. The acoustic features may also comprise other features such as voice type, regional accent, etc. For example, it may be determined if an inputted utterance is a child's voice. For example, children may have difficulty pronouncing the sound “sh”. Knowing that a voice command contains child's voice may help with identifying a name or command that might otherwise be unrecognizable from the transcript (e.g., simi simi), for example, for a popular children's show called Shimmy Shammy. Similarly, an acoustic feature associated with accent may contribute to determining a probable command that may be common for a group of people (e.g., people from a same region, background, etc.). The acoustic extraction model 520 may mark or tag an acoustic feature (e.g., as metadata) with a corresponding voice command, for example, by using an identifier (e.g., an ID number) associated with the voice command. Acoustic features may aid in determining probable commands, as will be described in further detail herein.

For the inputted utterance 501, the probable command generator 530 may receive (i) a transcript from the ASR engine 510, and/or (ii) acoustic feature data output from the acoustic extraction model 520. The probable command generator 530 may determine one or more probable commands, for example, if there is an error in the transcript and/or if the acoustic features indicate abnormality (e.g., truncation) in sound signals of the inputted voice command.

The probable command generator 530 may check if abnormality exists in sound signals of an inputted voice command. As described herein with respect to FIGS. 7A-7D, abnormality associated with an inputted utterance may comprise truncation, a click sound, and/or other noises. Some abnormalities (e.g., truncation) may affect the effectiveness of the voice command more than others (e.g., coughing sound). The acoustic feature data received from the acoustic extraction model 520 may indicate if there is an abnormality, type of the abnormality, and/or the probability of the abnormality. For example, acoustic feature data may indicate the detection of a possible head truncation in the inputted utterance and the probability (or possibility) of the head truncation. The following is an example of acoustic feature data that may be output from the acoustic extraction model 520:
{
   “recording_id”: “12345”,
   “analysis_result”: {
      “head_truncation_detected”: true,
      “probability”: 0.87
   },
   “message”: “Head truncation detected with a probability of 87%.”
}

The probable command generator 530 may determine if abnormality exists in sound signals of an inputted voice command, for example, based on acoustic feature data from the acoustic extraction model 520. If an abnormality exists, and as shown by arrow 531, the probable command generator may provide one or more probable commands and corresponding confidence levels to a consequence evaluator 540.

The consequence evaluator 540 may receive the transcript from the ASR engine 510, as shown by arrow 512, as well as the probable commands and corresponding confidence levels from the probable command generator 530 (e.g., if the probable command generator 530 determines an abnormality exists). The consequence evaluator 540 may communicate with a device context database 550 and/or a user experience model 560, for example, to send requests and/or to receive context information related to an associated device (e.g., the user device 310, the remote control device 320) and/or user data specific to the current user. The device context database 550 may be stored in a memory device such as the rewritable memory 203. The device context database 550 may receive information on real-time status of the user device 310 and/or the remote control device 320, including, for example, content (e.g., texts) of the current screen display, active/inactive status of software (e.g., APPs) in the user device, type of the remote control device (e.g., dedicated remote control device, cellphone, etc.), location of the device(s) (e.g., at home, on a moving vehicle, on a street, etc.), etc. The user experience model 560 may comprise a user experience database that may be stored in a memory device such as the rewritable memory 203. The user experience database may contain a record of queries, commands, and/or operations of one or more users for the user device. For example, the record may show that the current user has been using the user device (e.g., a smart TV) since January 2023. The most frequently used APPs include Netflix, YouTube, and Google. The top tags for the movies or shows played include superhero, action, sci-fi. The consequence evaluator 540 may determine an instruction associated with the user device 310, based on the transcript, the probable commands and confidence levels, the context information related to the user device, the user data specific to the current user, and/or other factors. As shown at arrow 541, consequence evaluator 540 may send that determined instruction to the computing device 315.

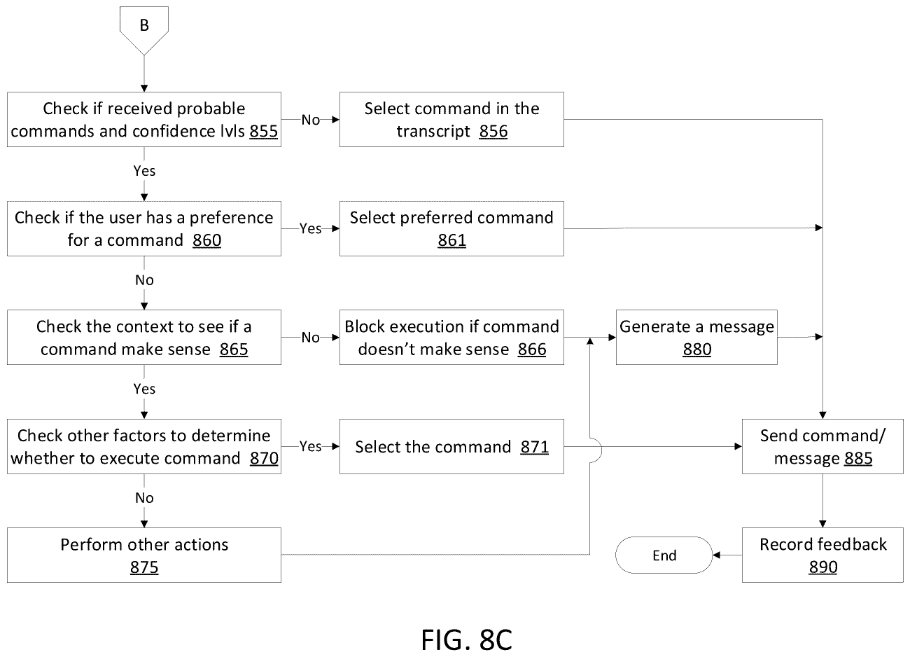

FIGS. 8A through 8C are a flow chart showing steps of an example method for processing an inputted utterance that may comprise truncation or other abnormalities, and that may comprise the example data flows described in connection with FIG. 5. For convenience, the method of FIGS. 8A-8C is described in the context of an example in which steps are performed by the query optimization server 122. However, one, some, or all steps of the example method may also or alternatively be performed by one or more other computing devices (e.g., the computing device 315 and/or other servers). One or more steps of the example method may be rearranged (e.g., performed in a different order and/or simultaneously), omitted, and/or otherwise modified, and/or other steps added.

In step 805, the server 122 may receive (e.g., from the remote control device 320 via the computing device 315), an inputted utterance (e.g., a voice command). Step 805 may, for example, correspond to the receipt of the inputted utterance 501 by the acoustic extraction model 520 and ASR engine 510 as described in connection with FIG. 5. In step 810, and as described in connection with FIG. 5, the server 122 (e.g., the ASR engine 510) may generate a transcript for the inputted utterance and provide (e.g., as shown by arrows 511 and 512 of FIG. 5) that transcript to the probable command generator 530 and the consequence evaluator 540. In step 815, the server 122 (e.g., the acoustic extraction model 520) may measure the volume (e.g., volume level, of voice) based on the inputted utterance. Step 815 may comprise, for example, measuring the volume level in relation to time, as described in connection with FIG. 5.

In step 820, the server 122 (e.g., the probable command generator 530) may determine if a received transcript is sensitive to truncation (or is a sensitive transcript). A transcript that is sensitive to truncation may be a transcript that would become a different command if truncation occurs. For example, “Netflix” when head-truncated, becomes “Flix” which might be transcribed to “Flex.” Flex may be part of a popular query or command. So “Netflix” is sensitive to truncation. A sensitive query may be included in and/or may include another popular query (e.g., having overlapping parts). The sensitivity may be tied with functions provided by a voice-controlled device, user patterns, latest trend, etc. In addition, user satisfaction scores for popular user queries may be used to identify queries that are sensitive to acoustic abnormalities such as truncation. For example, queries and associated responses that have very low user satisfaction scores may be sensitive to truncations. Sensitive queries or transcripts may be collected, built into a database, and updated. The server 122 (e.g., the probable command generator 530) may determine a transcript to be sensitive, for example, by checking the database. If a transcript is determined as sensitive to truncation, in step 825, and as described in connection with FIG. 5, the acoustic extraction model 520 may determine an indication of, and/or information regarding, truncation. For example, the acoustic extraction model 520 may determine and send information regarding truncation to the probable command generator 530, based on receiving a request from the probable command generator 530. If a transcript is determined as not sensitive to truncation, step 825 may be skipped, for example, to reduce workload of the acoustic extraction model 520. For example, the acoustic extraction model 520 may generate acoustic feature data other than truncation information, such as voice type, regional accent, etc. (in step 830). Note that the step 820 is optional. For example, the acoustic extraction model 520 may determine whether there is truncation or not (in step 825) immediately after step 815.

In step 825, as described in connection with FIG. 5, the acoustic extraction model 520 may determine information regarding truncation. For example, the acoustic extraction model 520 may determine presence of truncation (e.g., whether there is truncation or not), type of truncation (e.g., head truncation, tail truncation, middle truncation), probability of truncation (e.g., how likely a head truncation exists), etc. The acoustic extraction model 520 may make determinations associated with truncation, for example, based on volume levels (e.g., as measured and obtained in step 815). Abnormal volume levels (e.g., volume levels beyond a threshold or identified by a machine learning model), change of volume levels, and/or locations of these abnormal volume levels in audio data may be analyzed and/or used to determine truncation information. For example, different locations of abnormal volume levels may suggest different types of truncation. For example, the acoustic extraction model 520 may determine that a voice command comprises a head-truncated user speech (or head truncation), based on a volume level at a starting point of the voice command exceeding a threshold. The acoustic extraction model 520 may determine that a voice command comprises a tail-truncated user speech (or tail truncation), based on a volume level at an end point of the voice command exceeding a threshold. For example, an abrupt change at a beginning of a voice command may suggest a click sound and thus no head truncation. The determined truncation information (e.g., presence of truncation, type of truncation, probability of truncation, etc.) may be sent to the server 122 (e.g., the probable command generator 530), for example, as metadata, in step 830.

In step 830, and as also described in connection with FIG. 5, the acoustic extraction model 520 may generate acoustic feature data other than truncation information. The acoustic extraction model 520 may output (e.g., send) acoustic feature data (e.g., as metadata) to the probable command generator 530. The acoustic feature data may comprise the truncation information determined in step 825 and/or the other acoustic feature data generated in step 830.

In step 835 (FIG. 8B), the server 122 (e.g., the probable command generator 530) may check if the acoustic feature data received from the acoustic extraction model 520 suggest an abnormality in the inputted utterance (e.g., voice command). For example, the server 122 may check if the acoustic feature data (e.g., metadata) have any indications of abnormality (and/or probability of abnormality). As described in connection with FIG. 5, the abnormality may comprise truncation (e.g., as indicated by abnormal volume levels or change of volumes), a click sound, and/or other noises. As part of step 835, the server 122 may store one or more indications (e.g., set one or more flags) of whether the acoustic data suggest one or more abnormalities and/or of the type(s) of abnormality(ies) suggested.

In step 840, the server 122 (e.g., the probable command generator 530) may check if the transcript received from the ASR engine 510 has any error. The step 840 may be performed after, before, or simultaneously with the step 835. An erroneous transcript may be incomplete (e.g., missing words and/or punctuation), incorrect in grammar, misspelt, illogical, with extra words, etc. Some errors (e.g., repeated words, missing nonessential words such as “please”) might not affect the effectiveness of the transcript, and some other errors (e.g., absence or misspelling of essential words or punctuation) may have more impact. For example, “Let's play, Godfather!” has a different meaning from “Let's play Godfather!” For another example, “YouTube” may sound similar to “U2” (a music band), and mistranscription may happen. Erroneous transcripts may be collected and an error database (e.g., a repository of potential error transcripts) may be built, for example, based on historical user data. The error database may be stored in a memory device (e.g., the rewritable memory 203) accessible to the probable command generator 530 and may be constantly updated. The probable command generator 530 may check if the transcript matches any known erroneous transcript. For example, the probable command generator 530 may compare the received transcript with one or more similar transcripts in the error database. Alternatively or additionally, the probable command generator 530 may determine if a transcript contains an error, based on a database where correct commands are stored. The probable command generator 530, which may comprise a machine learning model (e.g., MLP model), may be trained using a large number (e.g., thousands) of transcripts of correct commands associated with a voice-controlled device (e.g., a multi-media device such as a smart TV). The probable command generator 530 may learn patterns (e.g., essential words) of these transcripts and may recognize a likely erroneous transcript if the transcript deviates from the patterns. The probable command generator 530, as a machine learning model, may determine a probability of the transcript being erroneous. As part of step 840, the server 122 may store one or more indications (e.g., set one or more flags) of whether the transcript has one or more errors and/or of the type(s) of error(s) suggested.

In step 843, the server 122 (e.g., the probable command generator 530) may determine next steps based on whether the transcript has one or more errors. If the transcript has one or more errors, in step 845, the server 122 (e.g., the probable command generator 530) may determine (e.g., evaluate) the necessity of correcting the transcript. If the transcript does not have any error, the server 122 (e.g., the probable command generator 530) may directly go to step 850 to determine one or more probable commands (or suggested transcripts).

In step 845, the server 122 (e.g., the probable command generator 530) may determine (e.g., evaluate) the necessity of correcting the transcript, for example, based on the output from step 835 and/or from step 840. For example, the probable command generator 530 may determine (e.g., calculate) a necessity score indicating how likely the transcript should be corrected, for example, by using exported probabilities, via a formula. For example, an output from step 835 may indicate that a recorded voice command has a head truncation with a probability of 87%. An output from step 840 may indicate that a transcript for this recorded voice command has an error with a probability of 90%. A necessity score may be a score (e.g., a value or a percentage) that is determined (e.g., calculated), for example, based on the probabilities 87% and 90%. The calculation may consider weight of each factor (e.g., based on an abnormality priority ladder). For example, the head truncation may have a higher weight than a coughing sound in the recorded voice command. Certain errors may have a higher weight than other errors. The calculation may consider the significance of the known probabilities. In this example, the necessity score may be a percentage that is higher than either percentage (e.g., the 87% or the 90%), as both known percentages are quite high. In another example, if the head truncation has a probability of 5%, while the transcript having an error has a probability of 96%, the necessity score may be still high despite the low probability of the head truncation, because the error probability is very high. The necessity scores may be determined based on formulas and/or using a machine learning model trained on a large amount of data with the probabilities. The formulas may be obtained from known rules and case studies, and may be dynamically updated. As part of step 845, the server 122 may store one or more indications (e.g., set one or more flags) of the necessity of correcting the transcript (e.g., store a necessity score).

In step 850, the server 122 (e.g., the probable command generator 530) may determine one or more probable commands (or suggested transcripts), for example, based on the transcript and/or information about the abnormality (e.g., truncation, etc.). The probable command generator 530 may optimize (e.g., autocorrect, determine a full command for, etc.) an incomplete and/or erroneous transcript, for example, by adding, changing, and/or deleting word(s) or part of a word. For example, a received command that has a transcript saying “netfli” may be optimized to “Open Netflix.” For example, if a transcript for a received command starts with “men” and has a 60% probability of a head truncation and a 10% probability of a tail truncation, probable commands may include “X-Men”, “Two and a Half Men”, “The Gentlemen”, etc. for the head truncation, “Men in Black”, “Men of War”, etc. for the tail truncation, and “X-Men: Apocalypse”, “Two Men and a Baby”, etc. for both head truncation and tail truncation. The probable command generator 530 may generate the one or more probable commands, for example, based on available catalogs of the voice-controlled device and/or service platforms (e.g., Peacock, Netflix, etc.), popular (and/or common) names and/or commands, historical user data, etc. For example, these data may be stored in a memory device (e.g., the rewritable memory 203) and accessible (e.g., retrievable) by the probable command generator 530. For example, these data may be stored in the form of a table (e.g., popular command intention table). The data may be updated. For example, the popular names and/or commands may change as hardware devices evolve, as recent events (e.g., Super Bowl) occur, etc. The probable command generator 530 may identify closest names and/or commands, for example, based on the transcript and abnormality information. The probable command generator 530 may determine a confidence level (e.g., a confidence score) for each probable command. The confidence level may be determined, for example, based on the probability of the abnormality. For example, in the example of “men”, the trail truncation has a much lower probability than that of the head truncation, which may mean that the transcript “men” is much more likely to be head truncated than tail truncated. As a result, a probable command based on head truncation such as “X-Men” may have a higher confidence score than a probable command based on tail truncation such as “Men in Black”. Additionally, the probable command generator 530 may determine the confidence level based on historical user data, popularity of a name or command, etc. For example, if the name “X-Men: Apocalypse” is more popular (e.g., appears more frequently in the data) than the name “Two Men and a Baby”, the name “X-Men: Apocalypse” may have a higher confidence score than that of the name “Two Men and a Baby”. The probable command generator 530 may, in step 850, send the probable commands and corresponding confidence levels (e.g., confidence scores) to the consequence evaluator 540, as shown by arrow 531 in FIG. 5.

After step 850, the server 122 (e.g., the consequence evaluator 540) may in step 855 (FIG. 8C) check if probable commands and corresponding confidence levels (e.g., confidence scores) have been received from the probable command generator 530. The consequence evaluator 540 may consider possible asynchrony between receiving the transcript from the ASR engine 510 and receiving the probable commands and corresponding confidence levels from the probable command generator 530. For example, for a same voice command, the consequence evaluator 540 may receive the probable commands and confidence levels with an around five-millisecond delay compared to receiving the transcript. The consequence evaluator 540 may wait until the delay is over (e.g., for around 5 ms), for example, before making the decision for step 855. In step 856, the server 122 (e.g., the consequence evaluator 540) may select the transcript (e.g., command in the transcript) as received from the ASR engine 510, for example, if no probable command has been received from the probable command generator 530. This situation may indicate that the probable command generator 530 has determined (e.g., in step 835 and/or step 840) that, for example, the sound signals are normal and/or the transcript is correct, or that the necessity score of correcting the transcript is low (e.g., in step 845). For example, the transcript may be same or similar to a correct command stored in a database and thus is considered executable. The command in the transcript may be sent to a user device 310 via a computing device 315 for execution. If the probable commands and corresponding confidence levels have been received, the server 122 (e.g., the consequence evaluator 540) may proceed to, for example, step 860.

In some examples, the server 122 (e.g., the consequence evaluator 540) may perform step 855 directly after step 835, without performing steps 840, 845, or 850. The server 122 (e.g., the probable command generator 530) may make the decision to not generate any probable command and to move to steps to be performed by the consequence evaluator 540, for example, if the acoustic feature data do not suggest an abnormality (e.g., with no abnormality or with a low probability of an abnormality) in step 835. In some other examples, the server 122 (e.g., the consequence evaluator 540) may perform step 855 directly after step 840, without performing steps 845 or 850. The server 122 (e.g., the probable command generator 530) may make the decision to not generate any probable command and to move to steps to be performed by the consequence evaluator 540, for example, if the transcript has no error or a low probability of an error. In some further examples, the server 122 (e.g., the consequence evaluator 540) may perform step 855 directly after step 845, without performing step 850. The server 122 (e.g., the probable command generator 530) may make the decision to not generate any probable command and to move to steps to be performed by the consequence evaluator 540, for example, if the transcript does not appear to need correction (e.g., if the necessity score is lower than a threshold). In all those situations, the consequence evaluator 540 may check and confirm that no probable command has been received from the probable command generator 530, and may move to step 856 in which the consequence evaluator 540 may use the transcript received from the ASR engine 510 to generate a command for the user device 310.

In step 860, the server 122 (e.g., the consequence evaluator 540) may check if the user has any preference for a command. For example, for a received utterance that has a tail-truncated word pronounced as “youtu”, one probable command may comprise “YouTube”, and another probable command may comprise “U2”. The consequence evaluator 540 may check a database such as the user experience database described herein. The consequence evaluator 540 may find that the user never issued a command involving “YouTube” and that the user listened to music from the band U2 frequently. That may indicate that the user has a preference for the command “U2”. Although the command “YouTube” may have a high confidence score, based on general historical user data (e.g., in 80% of all usage cases, “youtu” means “YouTube”), and the command “U2” may have a lower confidence score, the consequence evaluator 540 may, in step 861, select the command that has the user's preference, which is “U2” in this example. In another example, if probable commands include “X-Men”, “Two and a Half Men”, the consequence evaluator 540 may give priority to executing “X-Men” because a watching record for this relevant user may show most watched movies or shows being superhero, action, sci-fi movies or shows and no or few comedy or romance movies or shows. If there is no user preference for any command, the consequence evaluator 540 may proceed to, for example, step 865.

In step 865, the server 122 (e.g., the consequence evaluator 540) may check if the probable commands make sense in the context of an associated device (e.g., the user device 310). As described herein, the consequence evaluator 540 may check the device context database to determine a current status of the device (e.g., the user device 310). For example, the consequence evaluator 540 may find that the device is displaying a search result page (e.g., a current screen shows a search box or a search button). A probable command “Next page” may make sense. For example, if the consequence evaluator 540 finds that the device is in the middle of playing a movie, the probable command “Next page” might not make sense. In step 866, the consequence evaluator 540 may block execution of a command, for example, if the consequence evaluator 540 does not find that the command makes sense (e.g., does not find that the probable command matches the context of a current user device). In step 880, the server 122 (e.g., the consequence evaluator 540) may generate one or more messages, for example, to communicate with the user on information associated with blocked execution of a command, one or more actions, etc. If the server 122 determines in step 365 that the probable command does make sense, the consequence evaluator 540 may proceed to step 870.

In step 870, the server 122 (e.g., the consequence evaluator 540) may check other factors to determine whether to execute a command. The other factors may comprise confidence scores, significance of consequence of executing a command, etc. For example, a probable command that has a highest confidence score among multiple commands may be selected for execution. For example, turning off a TV may be more significant than pausing play. More significant commands may require higher confidence scores to be chosen for execution. In step 871, the consequence evaluator 540 may select a probable command. In step 885, the consequence evaluator 540 may send the command to the computing device 315 (and/or user device 310, “second computing device”, etc.) for execution (e.g., as shown by arrow 541 in FIG. 5). The consequence evaluator 540 in step 870 may not select a command for execution, for example, if the command has a very low confidence score or has a confidence score that is not high enough for a significant consequence.

In step 875, the server 122 (e.g., the consequence evaluator 540) may perform one or more other actions. For example, the consequence evaluator 540 may generate a new command, for example, if there is no executable command. The consequence evaluator 540 may determine a new command, for example, based on the current device context and/or the specific user experience data. For example, the probable command generator 530 may have generated multiple probable commands based on available catalogs, popular (and/or common) names and/or commands, general historical user data. The multiple probable commands might not include the command “Next page.” The consequence evaluator 540 may generate the command “Next page” based on the device being on a search result page and “Next page” being a high-frequency word in the specific user experience data. In some situations, the command generated by the consequence evaluator 540 may be the same as a probable command with a low confidence score. In those situations, the confidence score for this probable command may be increased by the consequence evaluator 540 and thus may be selected for execution. Alternatively or additionally, the consequence evaluator 540 may send signals to request user input to confirm a probable command, to educate the user to input a better voice command, and/or to suggest user check the battery power of the remote control or the network status, etc., for example, via one or more visual and/or verbal messages.

In step 885, the server 122 may send a command selected in step 856, step 861, or step 871, or a message generated in step 880, to the computing device 315, and/or via the computing device 315 to the user device 310 and/or the remote control device 320. A command sent to the computing device 315 may cause the computing device to cause the user device 310 to perform one or more actions. A message sent to the computing device 315, and/or via the computing device 315 to the user device 310 and/or the remote control device 320, may be displayed to the user. For example, the message may provide visual and/or audio instructions to the user. A command selected in step 856, step 861, or step 871 may also or alternatively comprise selection of content, in which case step 885 may comprise causing that selected content to be sent to the computing device 315 for output via the user device 310.

In step 890, the server 122 (e.g., the consequence evaluator 540) may record feedback (e.g., response) from the user device and/or the user, for example, after executing the command. For example, the user device may successfully switch to a movie as instructed in the command, and the server 122 may record the user device feedback as positive. The user device may fail to react and/or generate an error message, and the server 122 may record the device feedback as negative. For example, the user may say something like “Oh no”, “stupid”, “not what I want”, and/or may start inputting a similar voice command, and the server 122 may record the user feedback as negative. The recorded feedback may be used, for example, for the consequence evaluator 540, the probable command generator 530, etc. to adjust future operations. In addition, a successful activity such as playing of a movie may be recorded as metadata (e.g., name of the movie, etc.) and sent to, for example, the user experience model 560, as added user experience data.

As previously indicated, one, some, or all steps of the example method of FIGS. 8A-8C may also or alternatively be performed by one or more other computing devices. For example, operations associated with the consequence evaluator 540 (FIG. 5), described in connection with steps 855-890 of FIG. 8C, may be performed by the computing device 315. In that situation, the query optimization server 122 may send transcript (e.g., 512 in FIG. 5) and probable commands and confidence levels (e.g., 531 in FIG. 5) to the computing device 315, for example, via network 100, instead of sending to other software executing on the server 122.

### Test Example

The inventors studied one million queries with transcripts. 4.3% of the one million queries had head truncations, 4.4% had tail truncations, and 8.5% had both head and tail truncations. 3,000 utterances were annotated. Truncation detection accuracy rate using models such as those discussed in this disclosure (e.g., the acoustic extraction model 520) was above 80%.

Although examples are described above, features and/or steps of those examples may be combined, divided, omitted, rearranged, revised, and/or augmented in any desired manner. Various alterations, modifications, and improvements will readily occur to those skilled in the art. For example, although a handheld remote control device with a voice activation button is used as an example, any device capable of producing a speech signal may be used. For example, in the flow charts, one, some, or all steps of the example method may be performed by a single, a same, different, or multiple computing devices. One or more steps of the example method may be rearranged (e.g., performed in a different order and/or simultaneously), omitted, and/or otherwise modified, and/or other steps added. For example, step 810 and step 815 in FIG. 8A may be performed simultaneously. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a computing device, a voice command that comprises audio data for at least a portion of the voice command;
determining presence of truncation in the audio data, wherein said determining comprises analyzing volume levels in the audio data; and
determining, based on the determination of truncation, one or more probable commands.

2. The method of claim 1, wherein the determining the presence of truncation further comprises:
determining, based on location of abnormal volume levels in the audio data, a type of truncation.

3. The method of claim 1, wherein the determining the presence of truncation further comprises:
determining, based on a volume level at a starting point of the voice command exceeding a threshold, that the voice command comprises head-truncated user speech.

4. The method of claim 1, further comprising:
determining, based on a transcript of the voice command, sensitivity to truncation in the voice command,
wherein the determining the presence of truncation is based on the determined sensitivity.

5. The method of claim 1, wherein the determining the presence of truncation is based on one or more of:
status of hardware associated with generating the voice command; or
network quality associated with receiving the voice command.

6. The method of claim 1, further comprising:
generating a transcript of the voice command,
wherein the determining the one or more probable commands comprises determining, further based on the transcript, the one or more probable commands.

7. The method of claim 1, wherein the one or more probable commands are associated with a multi-media device, the method further comprising:
selecting, based on at least one of context information and user preference information associated with the multi-media device, a command of the one or more probable commands.

8. The method of claim 1, wherein the determining the presence of truncation comprises determining the presence based on a determined probability of truncation, the method further comprising:
determining a type of truncation; and
determining, based on the determined type of truncation and the determined probability of truncation, a confidence level associated with the one or more probable commands.

9. The method of claim 1, further comprising:
determining confidence levels for the one or more probable commands; and
selecting, based on the confidence levels, a command of the one or more probable commands.

10. The method of claim 1, further comprising:
sending an indication of a command, of the one or more probable commands, to a second computing device.

11. A method comprising:
receiving, by a computing device, audio data associated with a voice command;
determining, based on volume levels in the audio data, presence of truncation in the audio data;
generating a transcript of the voice command;
determining, based on the determination of truncation, a plurality of commands corresponding to the transcript;
selecting, based on at least one of context information and user preference information associated with a multi-media device, a command of the plurality of commands; and
causing performance, by the multi-media device, of the selected command.

12. The method of claim 11, wherein the determining the presence of truncation further comprises determining, based on location of abnormal volume levels in the audio data, a type of truncation.

13. The method of claim 11, wherein the determining the plurality of commands corresponding to the transcript is further based on comparing the transcript with common commands.

14. The method of claim 11, further comprising:
determining, for the transcript, sensitivity to truncation.

15. The method of claim 11, wherein the selecting the command is further based on confidence levels for the plurality of commands.

16. A method comprising:
receiving, by a computing device, a voice command that comprises audio data for at least a portion of the voice command;
determining, based on abnormal volume levels at a beginning or end of the audio data, a type of truncation in the audio data; and
determining, based on the determined type of truncation, one or more probable commands.

17. The method of claim 16, wherein the determining the type of truncation comprises:
determining, based on a volume level at a starting point of the voice command exceeding a threshold, that the voice command comprises head-truncated user speech.

18. The method of claim 16, wherein the determining the type of truncation comprises:
determining, based on a volume level at an end point of the voice command exceeding a threshold, that the voice command comprises tail-truncated user speech.

19. The method of claim 16, wherein the determining the type of truncation comprises:
determining the type based on comparing the volume levels and reference data.

20. The method of claim 16, further comprising:
sending a command, of the one or more probable commands, to a second computing device.
